(19) United States
(12) Patent Application Publication
(10) Pub. No.: US 2026/0024935 A1
(43) Pub. Date: Jan. 22, 2026

(54) CYLINDRICAL CONTACT AND A HIGH DENSITY MULTI-CONTACT RF CONNECTOR COMPRISING MEANS FOR EASY AND QUICK INSTALLING/REMOVING WITH LOCKING EACH CONTACT IN ITS INSTALLED POSITION

(71) Applicant: RADIALL SA, AUBERVILLIERS (FR)

(72) Inventors: Gong CHEN, Shanghai (CN); Kai Yang YUAN, Shanghai (CN)

(21) Appl. No.: 19/269,733

(22) Filed: Jul. 15, 2025

(30) Foreign Application Priority Data
Jul. 18, 2024 (WO) PCT/CN2024/106138

(51) Int. Cl. H01R 13/17; H01R 12/70; H01R 12/71; H01R 13/436; H01R 13/512

(52) U.S. Cl. CPC H01R 13/17; H01R 12/707; H01R 12/714; H01R 13/4361; H01R 13/512; H01R 2201/24

(57) ABSTRACT

The present application relates to a cylindrical contact which design allows it to be locked both longitudinally by a retention plate integral with or fixed onto a multi-contact connector housing and in rotation by a comb inserted and also fixed onto said housing.

### FIELD OF THE INVENTION

The present invention relates to a connection assembly comprising multi-contact connectors that are connected together.

More specifically, the invention concerns one of the multi-contact connectors of this assembly, also called a multi-channel connector, in which individual wired cylindrical, notably coaxial, contacts are accommodated. It concerns such a cylindrical contact.

By “wired coaxial contact”, it is to be understood a coaxial contact which is linked to an individual electrical cable, notably to transmit RF signals.

Although described with reference to a favoured application, the test and measurement market, the invention may be implemented in any other application dedicated to the commercial market. Thus, the invention may be applied generally to the connection in the medical domain, the aeronautical or transport domain, the space domain or even the telecommunications and data centers domain.

The favoured application concerns mainly a cable to board multi-channel electrical connector, intended to transmit RF signals, high speed signal up to a rate of 112 Gbps (gigabit per second), using for instance Pulse Amplitude Modulation (PAM) for digital coding, and especially PAM4 coding. The data speed rate could increase even more than 200 Gbps, for example 224 Gbps with PAM4 coding.

By “RF connector”, it is to be understood a connector able to transmit signals from the Direct Current (DC) range to the radiofrequency (RF) range, including the hyperfrequency (HF) range, the signals being high speed digital signals (HSDL for High-Speed Data Link) or radiofrequency (RF) signals.

### BACKGROUND OF THE INVENTION

With the development and widespread application of chip technology, artificial intelligence, big data, distributed storage and edge computing technology, data centers have increasingly needs for high speed rate and large bandwidth.

Therefore, the single-channel signal transmission speed has also increased from 56 Gbps to 112 Gbps and even reaching 224 Gbps in the future. Then, single-channel connectors will have to meet frequency requirements above 56 GHz, especially up to 67 GHz. As the transmission frequency reaches the millimeter wave range, high requirements are focused on the stability of cable assemblies and connectors used to transmit signals.

In addition, when users use high-density connectors or multi-channel connectors to test chips or PCBs (Printed Circuit Boards) performances, once a faulty connector or cable assembly is discovered, there is a need to quickly replace the faulty connector or cable assembly to reduce test and debugging time.

In other words, to test chips or PCBs it is necessary to quickly connect and disconnect a multi-contact connector having a high density of channels.

U.S. Pat. No. 10,505,293B2 discloses a multi-channel connector, configured as a plug, mated with a receptacle secured on a PCB, and comprising a plug housing in which individual wired coaxial contacts are installed axially and locked by inserting transversely a comb through an aperture on a side face of the plug housing. The comb is snapped on the plug housing and prevents each of the coaxial contacts from being removed rearwardly from the plug housing. However, a wired coax contact can slightly move axially in the plug housing in case of the pulling on the cable to which the contact is linked. This unwanted movement does not allow a stable connection of the coaxial contact with both the receptacle for the ground signal and the PCB for the center contact signal. Moreover, in case of faulty coaxial contact to be replaced, it is not easy or quick to remove the snapped-on comb and to relieve the cable strain.

Therefore, there exists the need to improve the multi-contact or multi-channel connectors notably configured as plug, such that to allow an easy and quick change of the wired coaxial contacts in the connector housing with a minimum of operations.

Moreover, all these components are subject to manufacturing tolerances.

Then, as mentioned above, the axial positioning of the wired coaxial contacts in the connector housing can slightly vary, due to cable pulling for instance. For example, during a test operation with a multi-contact connector, cables are plugged to a Vector Analyser Network-VNA-at their opposite end.

Finally, this unwanted displacement generates one or the other of the following problems and causes a loss of stability of the connection with the PCB (Printed Circuit Board):
a change of the contact pressure between the RF contact and the PCB and/or the connector, configured as a socket, fixed to the PCB;
a change of the electrical length of the electrical lines of the RF contacts;
a possible variation of the electrical length channel by channel of the contacts, due to different cable pulling forces.

Furthermore, the existing technology uses a RF contact with an outer body having an elastic portion, shaped with petals, to radially contact the connector (socket) housing fixed to the PCB. During the mating operation of the plug connector into the socket connector, the elastic portion will collide with the PCB socket cavity cylindrical surface. In the field of millimeter waves, the size of these petals is very small and relatively fragile, so the plug-in and unplug life of existing technology products is not very high, usually 500 times.

Consequently, there is a need to increase the robustness of the RF contacts in a multi-channel or multi-contact connector, to improve the stability of a RF contact axial positioning during its use life, and to lower the time of potential maintenance of the connector.

The invention aims to address all or part of these needs.

### SUMMARY OF THE INVENTION

Thus, the subject of the invention, according to one of its aspects, is a cylindrical contact of a central axis (X1), comprising:
a front portion including:
   a center contact,
   an outer cylindrical body,
   a solid insulating structure arranged between the center contact and the outer body;
a rear portion mounted sliding relative to the front portion along the central axis X1 including:
   a center contact plugged in or around the center contact of the front portion,
   an outer cylindrical body comprising, at its periphery,
   at least one projection extending outwardly radially and being intended to cooperate with a part of a multi-contact connector to form a longitudinal abutment,
   at least one flat surface being intended to cooperate with a part of a multi-contact connector to form a rotational abutment,
   a solid insulating structure arranged between the center contact and the outer body,
an elastic return means to achieve a variable length of sliding between the front and the rear portions under axial compression force.

According to an advantageous variant, the outer bodies of the front and the rear portions are conductive forming an outer contact.

Preferably, the projection of the outer cylindrical body of the rear portion is a lug.

According to an advantageous configuration, the outer cylindrical body of the rear portion comprises two opposite flat surfaces.

According to another advantageous configuration, the symmetry plane of two projections is aligned with the symmetry plane of the two flat surfaces.

Advantageously, the outer cylindrical body of the rear portion comprises two opposite projections.

According to an advantageous embodiment, the outer cylindrical body of the rear portion comprises a shoulder arranged at the rear of the projection.

According to an advantageous variant, elastic return means is an helical spring wound around the outer body of the rear portion and in abutment against both this latter and the outer body of the front portion.

According to a variant, the cylindrical contact is a coaxial contact.

Preferably, the center contact of the front portion is a pogo pin contact.

According to an advantageous embodiment, the cylindrical contact comprises a guiding portion by sliding between the rear and front portions.

A cylindrical contact according to the invention is advantageously configured to transmit RF (radiofrequency) signals or HSDL (High Speed Data Link) signals.

Another subject-matter of the invention is a multi-contact connector, notably configured as a plug, comprising:
a housing extending along a longitudinal axis (X), including:
   at least two cavities extending parallel to longitudinal axis (X) inside the housing or in an insert accommodated and fixed to the housing,
   a through hole slit extending transversally to longitudinal axis (X), at the rear of the cavities;
a retention plate integral with or fixed onto the rear of the housing, including:
   at least two through hole extending parallel to longitudinal axis (X), each through hole having at its periphery at least one cut-out face to one of the cavities;
at least one comb inserted into the through hole slit and fixed onto the housing, including:
   at least two pairs of adjacent teeth separated by an indentation, each tooth having flat side faces.

According to the invention, the at least one comb is arranged between the retention plate and the cavities such that a cylindrical contact according to any one of the preceding claims, after being inserted into one of the at least two through holes of the retention plate with the at least one projection inserted into the at least one cut-out, is accommodated in one of the at least two cavities with the at least one flat surface engaging one of the flat side faces of the teeth of the comb.

According to an advantageous variant, the cylindrical is accommodated in one of the at least two cavities with the at least one projection cylindrical contact being in a longitudinal abutment against the interior face of the retention plate.

According to another advantageous variant, the cylindrical contact is accommodated in one of the at least two cavities with the shoulder of the outer body of the rear portion abuts against the outer surface of the retention plate.

Preferably, the flat side faces of teeth of the comb are configured to prevent the rotation of the cylindrical contact.

Another subject-matter of the invention is a connection system comprising:
a multi-contact connector such as mentioned above, notably configured as a plug,
a complementary multi-contact connector, notably configured as a socket, comprising a cavity for receiving the multi-contact connector such as mentioned above,
a PCB with ground and signal tracks onto which the complementary multi-contact connector is intended to be mounted.

According to an advantageous variant, the multi-contact connector comprises fastening means configured to cooperate with complementary fastening means of the complementary multi-contact connector.

Preferably, the cavity of the complementary multi-contact connector is configured to transversely center the housing of the multi-contact connector.

Preferably, the complementary multi-contact connector is soldered to the PCB.

The invention concerns also a process for assembling a cylindrical contact such as mentioned above to a multi-contact connector such as mentioned above, comprising the following steps:
i/ insert axially the cylindrical contact through a through hole of the retention plate, aligning the at least one projection of the outer body with the at least one cut-out of the through holes;
ii/ once the cylindrical contact is inserted into the at least one cavity of the housing and at the least one projection being located between the retention plate and said cavity, rotating the cylindrical contact such that said projection cannot be extracted and preferably such that is the retention plate is sandwiched between said projection and the shoulder of the cylindrical contact;
iii/ insert the comb into the through hole slit such that at least one tooth of the comb slides along the at least one flat surface of the outer body of the cylindrical contact and then the gap between the at least one flat face of the tooth side and the at least one flat surface of the outer body of the cylindrical contact prevents the cylindrical contact from rotating back and being released from the housing of the multi-contact connector;
iv/ fix the comb onto the housing of the multi-contact connector.

In other words, the invention essentially consists in a cylindrical contact which design allows it to be locked both longitudinally by a retention plate integral with or fixed onto a multi-contact connector housing and in rotation by a comb inserted and also fixed onto said housing.

The cylindrical contact inserted and locked into the housing by the retention plate and the comb is wired previously being inserted into the housing. By “wired” it has to be understood that the contact is connected to and attached to a cable which transmits signals, notably RF signals.

The main advantages obtained by the multi-contact or multi-channel connector according to the invention, which comb locks in rotation a wired cylindrical contact which is also blocked longitudinally by the retention plate, are numerous and can be itemized as follows:
a secure locking of the wired contact, which implies that, even in vibrating environment, the wired contact cannot be released, preventing the disturbance of a RF line measurement linked to the contact;
a quick installation and/or repair of a wired contact: it simply consists on removing the comb from the housing of the connector to allow the release of the cylindrical contact;
stable RF line characteristics;
a robust design of electrical components (outer body, cylindrical contact) at their interface with the PCB: there is no brittle petal in contact with the PCB or the socket. The components that contact the PCB may have a robust «pogo-pin »-like design.

The invention also has an important advantage for the repair/maintenance.

Indeed, the multi-contact connector design can be easily repaired, in case of one defective wired cylindrical contact or defective cable.

The exchange process of a defective wired cylindrical contact can be done as follows:
transverse removal of the comb from the housing of the connector, notably previously by unscrewing or unlocking it;
rotation, notably by a ¼ turn, of the wired RF contact in order to align projection(s) with the cut-out(s) of the trough hole of the retention plate;
pull the defective cylindrical contact and remove it from the housing of the connector.

The installation of a new cylindrical contact can be done with the same steps of the process of assembly such as described below except that, when inserting the new wired contact in the cavity of the housing, apply a slight axial force to compress the elastic means, before rotation of the contact.

### BRIEF DESCRIPTION OF THE DRAWINGS

Other advantages and features of the invention will become more apparent upon reading the detailed description of exemplary implementations of the invention, given by way of non-limiting illustrations, and with reference to the following figures, in which:

FIG. 1 is a perspective view of a multi-contact connector according to the invention, configured as a plug and a complementary multi-contact connector, configured as a socket and intended to be mounted to a PCB;

FIG. 2 is an exploded view of a multi-contact connector according to the invention and wired cylindrical contacts according to the invention to be accommodated into said connector;

FIG. 3 is a perspective view of the housing of a multi-contact connector according to invention;

FIG. 4 is a top view of a retention plate according to the invention to be fixed onto the housing of FIG. 3;

FIG. 5 is a perspective view of a comb according to the invention to be fixed onto the housing of FIG. 3;

FIG. 6 is a top view of a comb according to FIG. 5;

FIG. 7 is a perspective view of a wired cylindrical contact according to the invention;

FIG. 8 is a longitudinal section view of the wired cylindrical contact according to FIG. 7;

FIG. 9 is a front view of the wired cylindrical contact according to FIG. 7;

FIG. 10 are a perspective and longitudinal section views of the rear part of a wired cylindrical contact according to FIG. 7;

FIG. 11 is a perspective and partial longitudinal section view of the wired cylindrical contact according to FIG. 7, at the level of the guiding portions of the rear and front parts of said contact;

FIG. 12 shows a wired cylindrical contact at the beginning of its insertion into a through hole of the retention part according to the invention;

FIG. 13A to 13D show different steps of the assembling process of a wired cylindrical contact in a multi-contact connector according to the invention;

FIG. 14 shows the assembly of several wired cylindrical contacts in a multi-contact connector according to the invention (partial longitudinal section).

### DETAILED DESCRIPTION

Throughout this application, the terms “interior” and “exterior” are to be understood in relation to a connection assembly according to the invention.

Throughout the present application, the terms “front”, “rear”, “top”, and “bottom” should be considered with reference to a connection assembly of the invention having two mutually-connected connectors 2, 3. Thus, the front face of the connector 3, which can also be referred to as its “connection” face, is the face beside which the connection is made with the complementary connector 2.

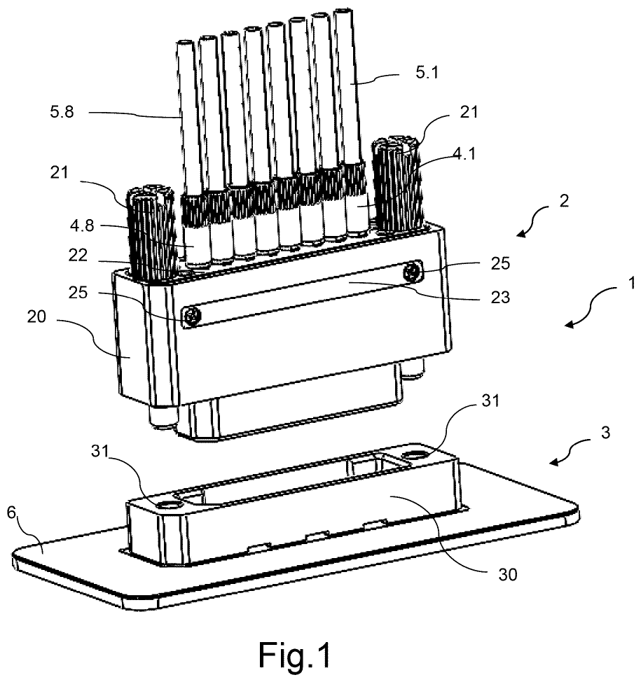

FIG. 1 shows a connection assembly given overall reference 1 in a first embodiment of the invention. This connection assembly 1 comprises a first multi-contact connector given overall reference 2 and a second multi-contact connector given overall reference 3. The multi-contact connectors 2 and 3 are of complementary type, it being possible, by way of example, for the first connector 2 to be of the male type and in particular to be a plug, while the second connector 3 is of the female type, being in particular a socket.

However, in all of the described figures, the first connector 2 is a male plug and the second connector 3 is a female socket.

The multi-contact connector 2, conveys electrical signals, or power. In a variant, signals or power of different types may be conveyed by each of the multi-contact connector, in which case contacts of different sizes and different types are arranged simultaneously in the connector.

As illustrated, the multi-contact connector 2, configured as a plug, accommodates cylindrical contacts 4.1 to 4.8, each wired to a cable 5.1 to 5.8, intended to transmit RF or high speed data signals, herein after called wired RF cylindrical contacts. Each wired RF cylindrical contact 4.1 to 4.8 may be single or multiple contacts such as coaxial or tri-axial contacts, quadrax contacts.

Each of the first multi-contact connector 2 and the second multi-contact connector 3 mainly comprises a housing 20, 30 that is made as a single piece of electrically conductive or insulating material.

The muti-contact connector 3, configured as a socket, receives the multi-contact connector 2, configured as a plug in order to connect the wired RF cylindrical contacts directly with tracks (ground and signal) of a PCB 6 onto which the connector 3 is mounted. Preferably, the housing 30 of the socket 3 can be soldered notably by SMT (Surface mount technology) process or screwed to the PCB. Preferably, the socket housing 3 is made of copper or copper alloy, with a surface coating, preferably a gold coating, allowing the soldering with the PCB. The ground signal may not go through the socket 3 to the PCB.

The multi-contact connector 2, configured as a plug may have no function of grounding, that is to say conducting the ground signal from the wired RF contacts 4.1 to 4.8 to the PCB.

The housing 20 may comprise one or several screws 21, notably two screws, accommodated in corresponding through holes 201 arranged on both lateral sides of the housing 20, to cooperate by screwing with one or several threads 31, notably two threads arranged on both lateral sides of the housing 30, to fasten the two connectors mutually.

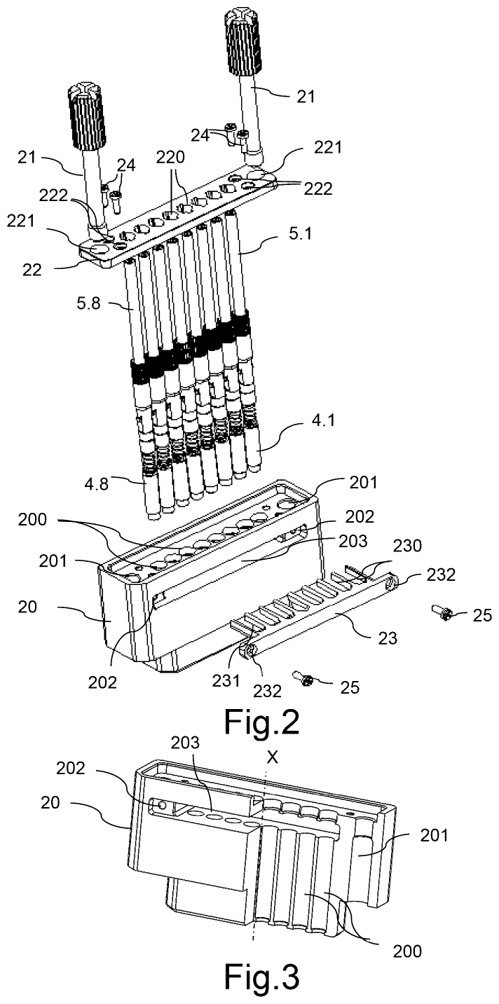

As shown on FIGS. 2 and 3, the housing 20 extends along a longitudinal axis X and includes a plurality of parallel cavities 200 arranged along axis X in the housing 20 extending from a rear face to a front face, which face may also be referred to a “connection” face, so as to face the second connector 3 when the connectors 2 and 3 are locked together.

Each of the cavities 200 usually receives a portion of the wired RF cylindrical contacts 4.1 to 4.8 as explained below.

The housing 20 also comprises a through hole slit 203 extending transversally to the longitudinal axis (X), at the rear of the cavities 200.

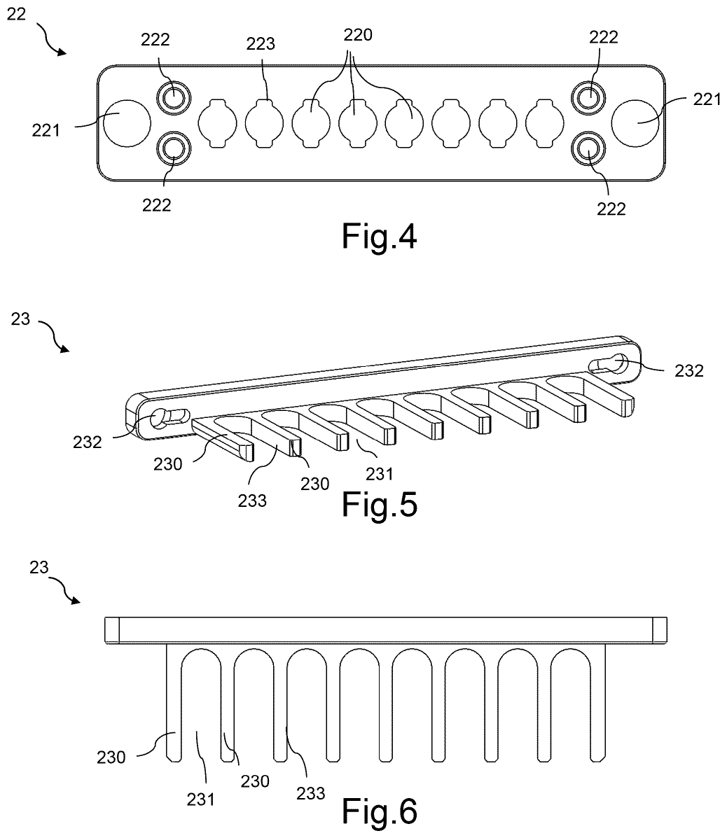

The multi-contact connector 2 also includes a retention plate 22 fixed onto the rear of the housing, The retention plate is shown in details on FIG. 4. Alternatively, for instance using a 3D printing manufacturing, the retention plate 22 could be integral with the housing 20.

The retention plate 22 includes a plurality of through holes 220 extending parallel to longitudinal axis (X), each through hole having at its periphery at least one cut-out 223 facing one of the cavities 200 of the housing 20. Cut-outs 223, two in the shown example, are angularly positioned around a through hole 220 so that the pitch between adjacent through holes 220 can be minimized, in order to increase contacts density, i.e. the number of wired RF cylindrical contacts 4.1 to 4.8 to be accommodated in the housing 20.

The retention plate 22 also includes through holes 221, notably on its two lateral sides to let the passage of screws 21.

The retention plate 22 also includes through hole 222 to cooperate with screws 24 to fasten the retention plate 22 to the housing 20.

The multi-contact connector 2 includes also a comb 23 inserted into the through hole slit 203 and fixed onto the housing 20, as shown in detail on FIGS. 5 and 6.

The comb 23 includes a plurality of pairs of adjacent teeth 230 separated by an indentation 231, each tooth 230 having flat side faces 233.

The comb 23 also includes through holes 232, notably on its two lateral sides to let the passage of screws 25 to fasten the comb 23 to the housing 20.

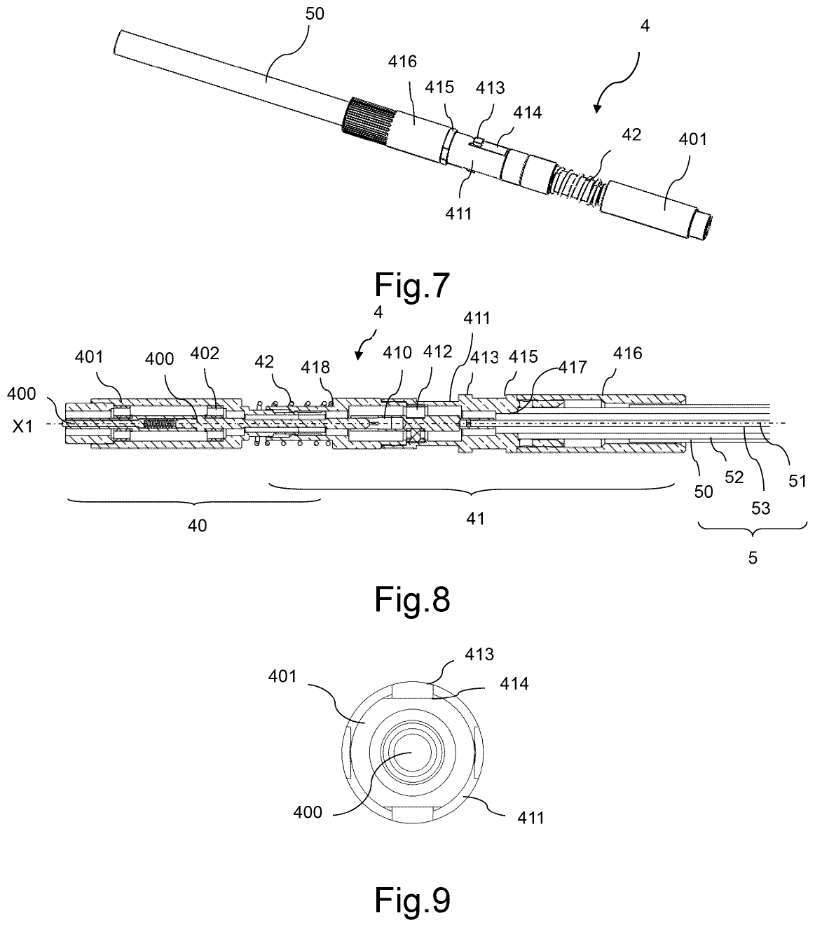

As shown in detail on FIGS. 7, 8 and 9, a cylindrical contact 4 of a central axis (X1), is wired to a RF cable 5.

Cable 5 comprises an outer sheath 50 of electrical insulating material and an electrical conductor 51, insulated from the outside by the outer sheath 50.

Cable 5 also includes a metal braid 52 for electromagnetic shielding surrounding the insulated conductor.

An electrical insulating sheath 53 is interposed between the core 51 of the insulated conductor and the metal braid 52.

According to the invention, the RF wired cylindrical contact 4 comprises a front portion 40 and a rear portion 41 mounted and guided by sliding onto the front portion.

The front portion 40 includes a center contact 400, which is a pogo pin contact, an outer cylindrical body 401, which is conductive and forms an outer contact, and a solid insulating structure 402 arranged between the center contact 400 and the outer body 401.

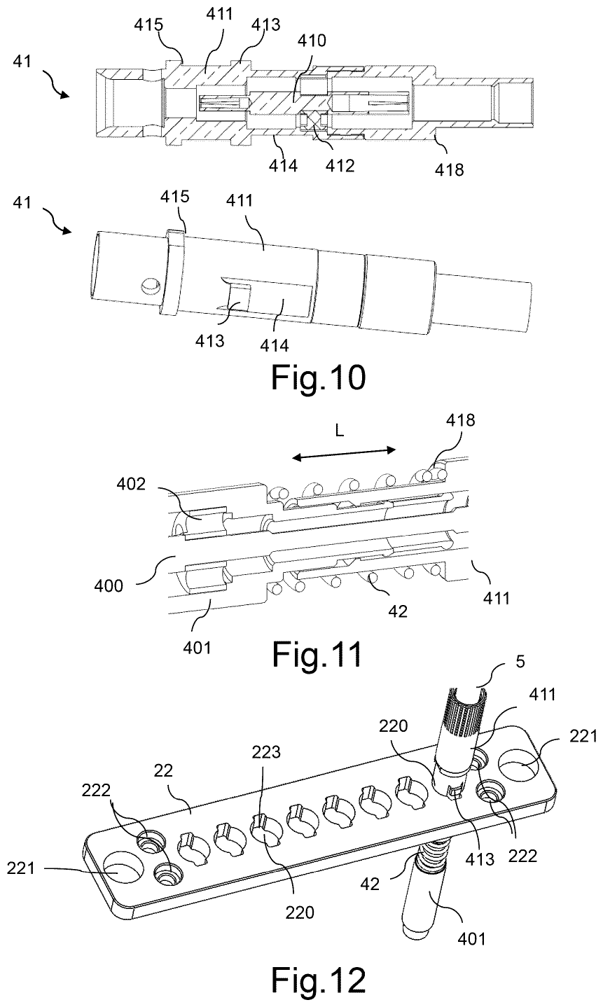

The rear portion 41, shown in detail on FIG. 10, includes a center contact 410 plugged in or around the center contact 400 of the front portion 40, an outer cylindrical body 411, which is conductive and forms an outer contact, and a solid insulating structure 412 arranged between the center contact 410 and the outer body 411.

The outer cylindrical body 411 comprises, at its periphery, two opposite flat surfaces 414 being intended to cooperate with a part of the multi-contact connector 2 to form a rotational abutment as discussed below, and two opposite projections 413, preferably lugs, extending outwardly radially and being intended to cooperate with a part of the multi-contact connector 2 to form a longitudinal abutment, as discussed below.

As shown in FIGS. 7 to 9, the symmetry plane of two projections 413 is aligned with the symmetry plane of the two flat surfaces 414.

The outer cylindrical body 411 of the rear portion comprises also a shoulder 415 arranged at the rear of the projection 413 and which allows to stop the insertion of a RF wired contact 4 into the housing 20 of the connector 2.

Additionally, the rear portion 41 has means, sleeve-like part 416 for protection of cable and a soldering point 417. Thus, the metal braid 52 of the cable 5 is welded to rear portion 41 by this soldering point 417. The sleeve 416 is pressed onto the rear portion 41, at the rear of the shoulder 418, protecting both cable and the soldering point.

Finally, the outer body comprises a shoulder 418.

A cylindrical contact 4 includes also an elastic return means to achieve a variable length of sliding between the front and the rear portions 40, 41 under axial compression force. As shown in the illustrated examples, elastic return means is an helical spring 42 wound around the outer body 411 of the rear portion 41 and in abutment against the shoulder 418 of the rear portion 41 and the outer body 401 of the front portion 40.

As mentioned, front and rear portions 40, 41 of a RF wired contact 4 can slide in relation to each other, under the compression force of the helical spring 42, and when the connector is 2 is mated to the connector 3 itself mounted on the PCB 6.

According to a preferred embodiment of the invention, illustrated on FIG. 11, the front portion outer body 401 slides inside the rear portion outer body 411 with guiding areas of both outer bodies under the form of solid cylinders. Thanks to the possible long length L of the guiding area, the tilt angle between the front 40 and the rear 41 portion is limited. This helps to correctly position the front tip 400, of the wire RF contact 4 when compressed against a track of a PCB onto which the connector 3 is mounted.

According to the invention, the comb 23 of the connector 2 is arranged between the retention plate 22 and the cavities 200 such that a cylindrical contact 4, after being inserted into one of the through holes 220 of the retention plate 22 with the two projections 413 each inserted into one of the two cut-outs 223 (FIG. 12), is accommodated in one of the cavities 200 with the two flat surfaces 414 engaging the two flat side faces 233 of a tooth 230 of the comb 23.

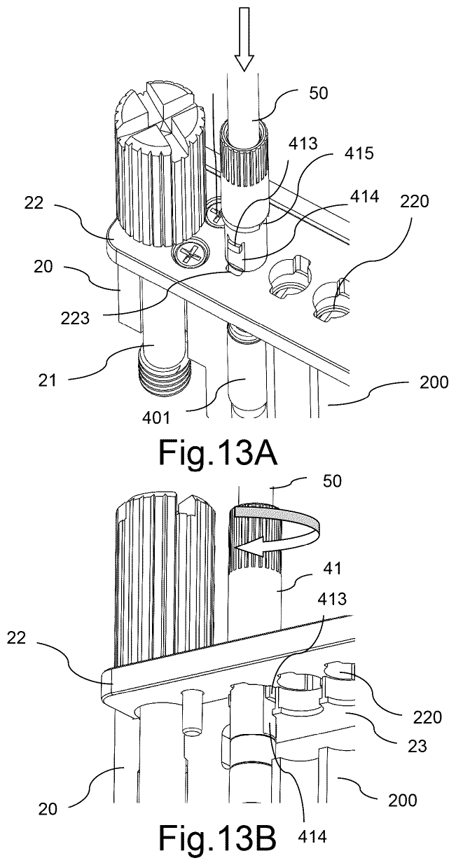

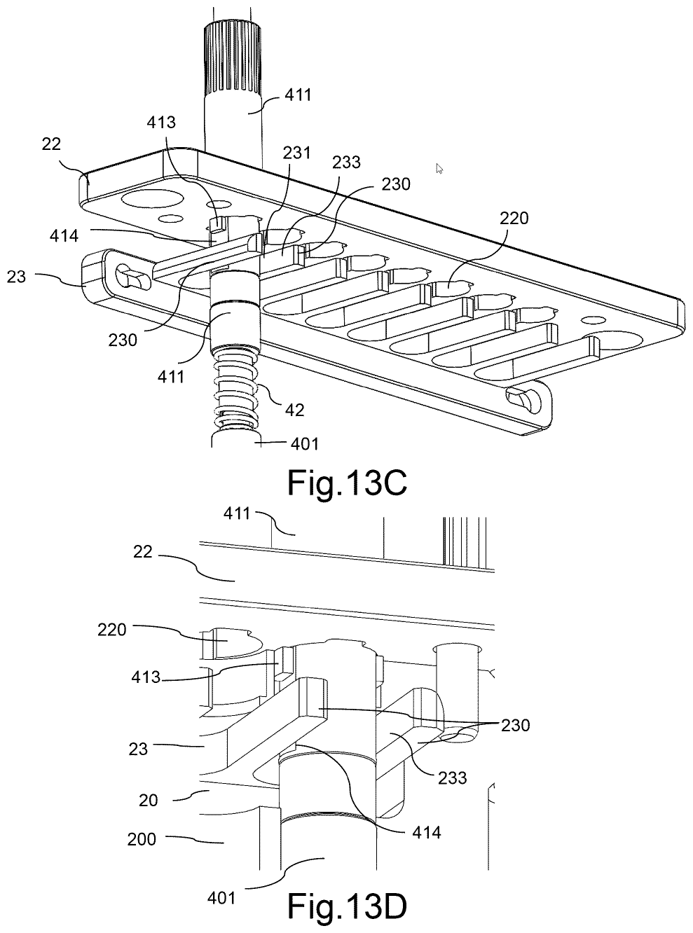

A process for assembling a cylindrical contact 4 to a multi-contact connector 2 such as described above is now described in relation to FIGS. 13A to 13D.

Previously, the housing 20 of the connector 2 may be pre-assembled with the fastening screws 21 and the retention plate 22 screwed to the housing 20 by screws 24.

Wired RF contacts 4 and the comb 23 with its fixing screws 25 may be supplied separately.
Step i/: the cylindrical contact 4 is inserted axially through a through hole 220 of the retention plate 22, aligning the two projections 413 of the outer body 41 with two cut-outs 223 of the through holes 220 (FIG. 13A). When completely inserted, the shoulder 415 on the outer body 41 abuts against the external surface of the retention plate 22.
Step ii/: once the cylindrical contact 4 is inserted into the cavity 200 of the housing 20 and at the two projections 413 being located between the retention plate 22 and said cavity 200 with the shoulder 415 in abutment against the retention plate 22, then the cylindrical contact 4 is rotated such that said projections 413 cannot be extracted and the retention plate 22 is sandwiched between said projections 413 and the shoulder 415 of the cylindrical contact 41 (FIG. 13B). The rotation of the cylindrical contact 4 can be approximately with a ¼ turn as in the illustrated example.

In this installed position, the wired RF contact 4 is spring-loaded by the helical spring 42. These steps i/ and ii/ are repeated for each of the wired RF cylindrical contacts 4.1 to 4.8 that have to be accommodated into the cavities of the housing 20. Of course, one or several cavities 200 can remain empty.

Step iii/: the comb 23 is inserted into the through hole slit 203 of the housing 20 such that the tooth 230 of the comb 23 slides along the two flat surfaces 414 of the outer body 41 and then the gap between the two flat faces 233 of the tooth side and the two flat surfaces 414 of the outer body 41 prevents the cylindrical contact 4 from rotating back and being released from the housing 20 (FIGS. 13C and 13D).

Step iv/: finally, the comb 23 is fixed onto the housing 20 by screwing each of the screws 25 into a thread 202 of the housing.

The assembly process between the two connectors 2, 3 is as follows.

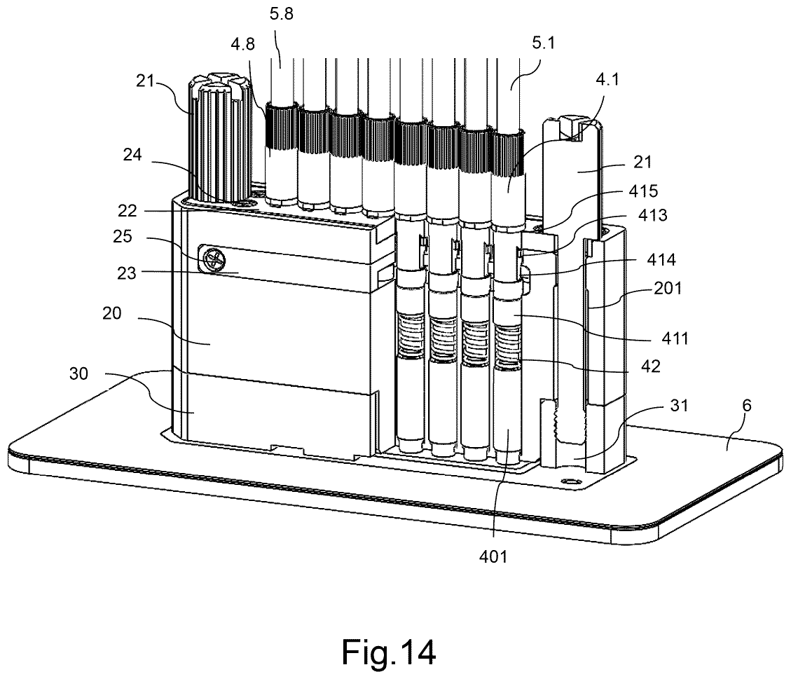

As shown on FIG. 14, the connector 2, equipped with its wired RF contacts 4.1 to 4.8, is fixed to the connector 3 by screwing screws 21 into threads 31, the connector 3 being already fixed, preferably by solder, to a PCB 6. The housing 30 centers the housing 20 in order that the RF contacts 4.1 to 4.8 are aligned and connect with the tracks of the PCB.

When the connector 2 is screwed on the connector 3, the spring 42 of each wired RF contact 4.1 to 4.8 is slightly compressed, and then pushes the projections 413 against the internal face of the retention plate 22.

As a consequence of the slight contact pressure involved by the spring, the pulling force eventually applied on a cable 5.1 to 5.8 cannot change the contact force of the front outer body 401 and of the center contact 400 against the PCB. The pulling force on the cable cannot modify the electrical length of each of the wired RF contacts 4.1 to 4.8, as this latter is always abutting against the retention plate 22 thanks to the projections 413.

Then the connection becomes more stable than in the prior art, and the phase delay, related to the electrical length of the RF line, is similar for all channels 4.1 to 4.8.

Moreover, the comb 23, by locking the rotation of each of the wired RF contacts 4.1 to 4.8, prevents this latter from being accidentally released and disconnected.

Other variants and enhancements can be provided without in any way departing from the framework of the invention.

For example, the housing 20 could be made of two parts, one being the surrounding walls, the other being an insert with the cavities. Both parts would be assembled before the insertion of the contacts.

For example, if the illustrated embodiments show a RF coaxial contact as a cylindrical contact, any kind of known cylindrical contacts can be implemented like twinax contact, triaxial contact, quadrax contact, octoax contact.

The number of wired RF contacts may be usually eight, as shown in the illustrated examples, but it can vary from two to thirty-two or more, depending on the application. It is possible to have two parallel rows of eight contacts, or more, to increase the number of channels, with one comb or two oppositely mounted combs.

The expression “comprising a” should be understood to be synonymous with “comprising at least one”, unless otherwise specified.

In the framework of the invention, one or several cavities of the housing of the multi-contact connector can remain empty. In other words, each cavity of the multi-contact connector can accommodate a cylindrical contact or not.

1. A cylindrical contact of a central axis, comprising:
a front portion including:
a center contact,
an outer cylindrical body,
a solid insulating structure arranged between the center contact and the outer body;
a rear portion mounted sliding relative to the front portion along the central axis including:
a center contact plugged in or around the center contact of the front portion,
an outer cylindrical body comprising, at its periphery,
at least one projection extending outwardly radially and being intended to cooperate with a part of a multi-contact connector to form a longitudinal abutment,
at least one flat surface being intended to cooperate with a part of a multi-contact connector to form a rotational abutment,
a solid insulating structure arranged between the center contact and the outer body,
an elastic return means to achieve a variable length of sliding between the front and the rear portions under axial compression force.

2. The cylindrical contact according to claim 1, wherein the outer bodies of the front and the rear portions are conductive, forming an outer contact.

3. The cylindrical contact according to claim 1, wherein the projection of the outer cylindrical body of the rear portion is a lug.

4. The cylindrical contact according to claim 1, wherein the outer cylindrical body of the rear portion comprises two opposite projections.

5. The cylindrical contact according to claim 4, wherein the outer cylindrical body of the rear portion comprises two opposite flat surfaces.

6. The cylindrical contact according to claim 5, wherein the symmetry plane of two projections is aligned with the symmetry plane of the two flat surfaces.

7. The cylindrical contact according to claim 1, wherein the outer cylindrical body of the rear portion comprises a shoulder arranged at the rear of the projection.

8. The cylindrical contact according to claim 1, wherein elastic return means is an helical spring wound around the outer body of the rear portion and in abutment against both this latter and the outer body of the front portion.

9. The cylindrical contact according to claim 1, being a coaxial contact.

10. The cylindrical contact according to claim 1, wherein the center contact of the front portion is a pogo pin contact.

11. The cylindrical contact according to claim 1, comprising a guiding portion (L)-by sliding between the rear and front portions.

12. The cylindrical contact according to claim 1, configured to transmit RF (radiofrequency) signals or HSDL (High Speed Data Link) signals.

13. A multi-contact connector, comprising:
a housing extending along a longitudinal axis, including:
at least two cavities extending parallel to the longitudinal axis inside the housing or in an insert accommodated and fixed to the housing,
a through hole slit extending transversally to the longitudinal axis, at the rear of the cavities;
a retention plate integral with or fixed onto the rear of the housing, including:
at least two through hole extending parallel to longitudinal axis, each through hole having at its periphery at least one cut-out face to one of the cavities;
at least one comb inserted into the through hole slit and fixed onto the housing, including:
at least two pairs of adjacent teeth separated by an indentation, each tooth having flat side faces;
wherein the at least one comb is arranged between the retention plate and the cavities such that a cylindrical contact according to claim 1, after being inserted into one of the at least two through holes of the retention plate with the at least one projection inserted into the at least one cut-out, is accommodated in one of the at least two cavities with the at least one flat surface engaging one of the flat side faces of the teeth of the comb.

14. The multi-contact connector according to claim 13, wherein the cylindrical contact is accommodated in one of the at least two cavities with the at least one projection cylindrical contact being in a longitudinal abutment against the interior face of the retention plate.

15. The multi-contact connector according to claim 13, wherein the cylindrical contact is accommodated in one of the at least two cavities with the shoulder (415) of the outer body of the rear portion abuts against the outer surface of the retention plate.

16. The multi-contact connector according to claim 13, wherein the flat side faces of teeth of the comb are configured to prevent the rotation of the cylindrical contact.

17. A connection system comprising:
a multi-contact connector according to claim 13,
a complementary multi-contact connector comprising a cavity for receiving the multi-contact connector
a PCB with ground and signal tracks onto which the complementary multi-contact connector is intended to be mounted.

18. The connection system according to claim 17, wherein the multi-contact connector comprises fastening means configured to cooperate with complementary fastening means of the complementary multi-contact connector.

19. The connection system according to claim 17, wherein the cavity of the complementary multi-contact connector is configured to transversally center the housing of the multi-contact connector.

20. The connection system according to claim 17, wherein the complementary multi-contact connector is soldered to the PCB.

21. A process for assembling a cylindrical contact to a multi-contact connector according to claim 13, comprising the following steps:
i/ insert axially the cylindrical contact through a through hole of the retention plate, aligning the at least one projection of the outer body with the at least one cut-out of the through holes;
ii/ once the cylindrical contact is inserted into the at least one cavity of the housing and at the least one projection being located between the retention plate and said cavity, rotating the cylindrical contact such that said projection cannot be extracted and;
iii/ insert the comb into the through hole slit such that at least one tooth of the comb slides along the at least one flat surface of the outer body of the cylindrical contact and then the gap between the at least one flat face of the tooth side and the at least one flat surface of the outer body of the cylindrical contact prevents the cylindrical contact from rotating back and being released from the housing of the multi-contact connector;
iv/ fix the comb onto the housing of the multi-contact connector.

22. The process according to claim 21, wherein step ii/ is achieved such that the retention plate is sandwiched between said projection and the shoulder of the cylindrical contact.
